(19) United States
(12) Patent Application Publication
(10) Pub. No.: US 2012/0287009 A1
(43) Pub. Date: Nov. 15, 2012

(54) SOLID ANTENNA

(75) Inventors: HSIN-LUNG TU, Tu-Cheng (TW); HUANG-CHAN LIN, Tu-Cheng (TW)

(73) Assignee: HON HAI PRECISION INDUSTRY CO., LTD., Tu-Cheng (TW)

(21) Appl. No.: 13/457,413

(22) Filed: Apr. 26, 2012

(30) Foreign Application Priority Data
May 10, 2011 (CN) 201110119619.0

(51) Int. Cl. H01Q 1/48

(52) U.S. Cl. 343/845

(57) ABSTRACT

A solid antenna disposed on a substrate includes a first grounding portion disposed on the substrate, a feeding portion perpendicular to the substrate, a radiating portion, and a coupling portion disposed on the substrate and separated from the radiating portion. The radiating portion includes a first radiating part, a second radiating part, a connection part, a third radiating part perpendicularly connected to the feeding portion, and a fourth radiating part connected in series. The second radiating part, the connection part, and the third radiating part are disposed on a plane parallel with the substrate. Both the first radiating part and the fourth radiating part extend from the plane to the substrate. The coupling portion is disposed on the substrate and is separated from the radiating portion.

### BACKGROUND

1. Technical Field

The present disclosure relates to antennas, and more particularly to a solid antenna.

2. Description of Related Art

Wireless communication technologies allow mobile communication products integrated with communication modules to not only communicate with local area networks and transmit e-mails, but also receive real-time information such as news and stock information.

An antenna is a key component of each mobile communication product. Miniaturization design on the antenna is essential for volume reduction to a smaller-size mobile communication product. Thus, a smaller and less intrusive fitted antenna provides a better user experience.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 shows a schematic view of an embodiment of a solid antenna in an aspect in accordance with the present disclosure.

FIG. 2 shows a schematic view of an embodiment of a solid antenna in another aspect in accordance with the present disclosure.

FIG. 3 shows a schematic view of partial enlargement of the solid antenna shown in FIG. 1 in accordance with the present disclosure.

FIG. 4 shows a schematic view of exemplary dimensions of the solid antenna shown in FIG. 1 in accordance with the present disclosure.

FIG. 5 shows exemplary return loss measurement for the solid antenna shown in FIG. 1 in accordance with the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

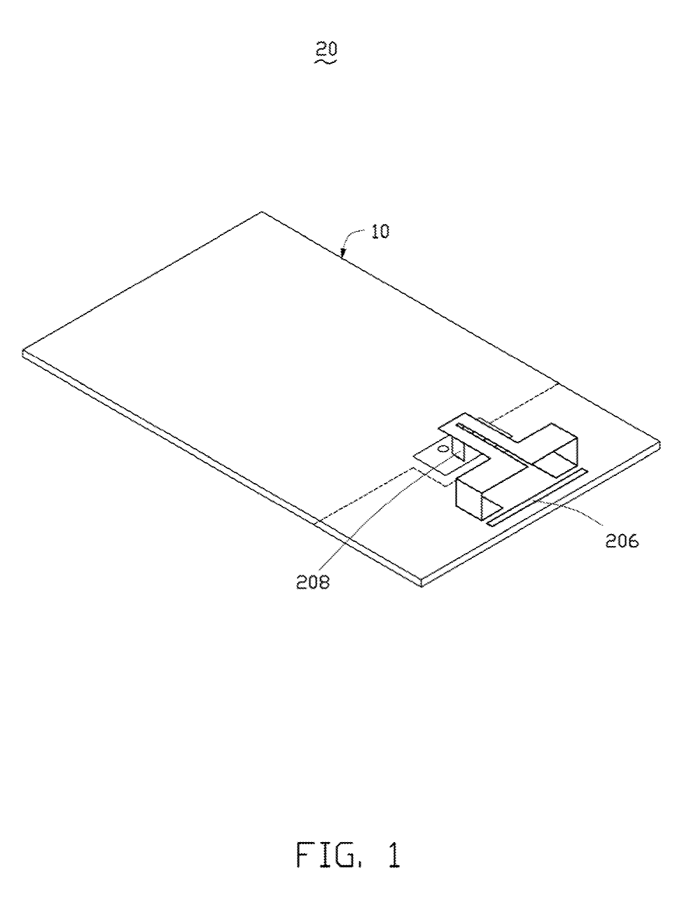

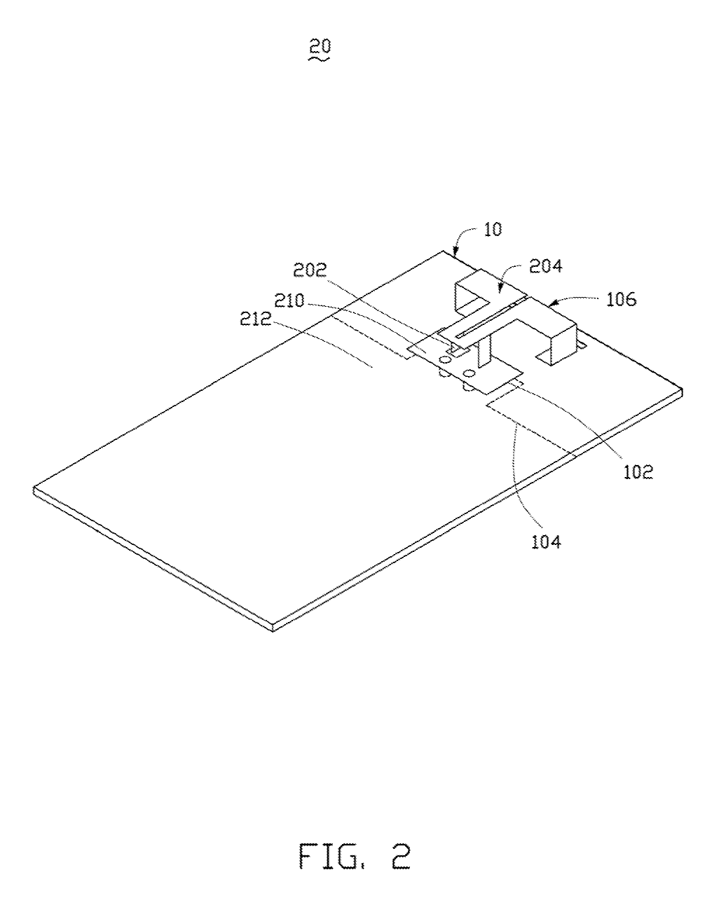

FIGS. 1 and 2 show schematic views of an embodiment of a solid antenna 20 in different aspects in accordance with the present disclosure.

In the present embodiment, the solid antenna 20 is disposed on a substrate 10. As shown in FIG. 2, the substrate 10 includes a first surface 102 and a second surface 104 opposite to the first surface 102. The solid antenna 20 includes a feeding portion 202, a radiating portion 204, and a coupling portion 206, a shorting portion 208, a first grounding portion 210, and a second grounding portion 212.

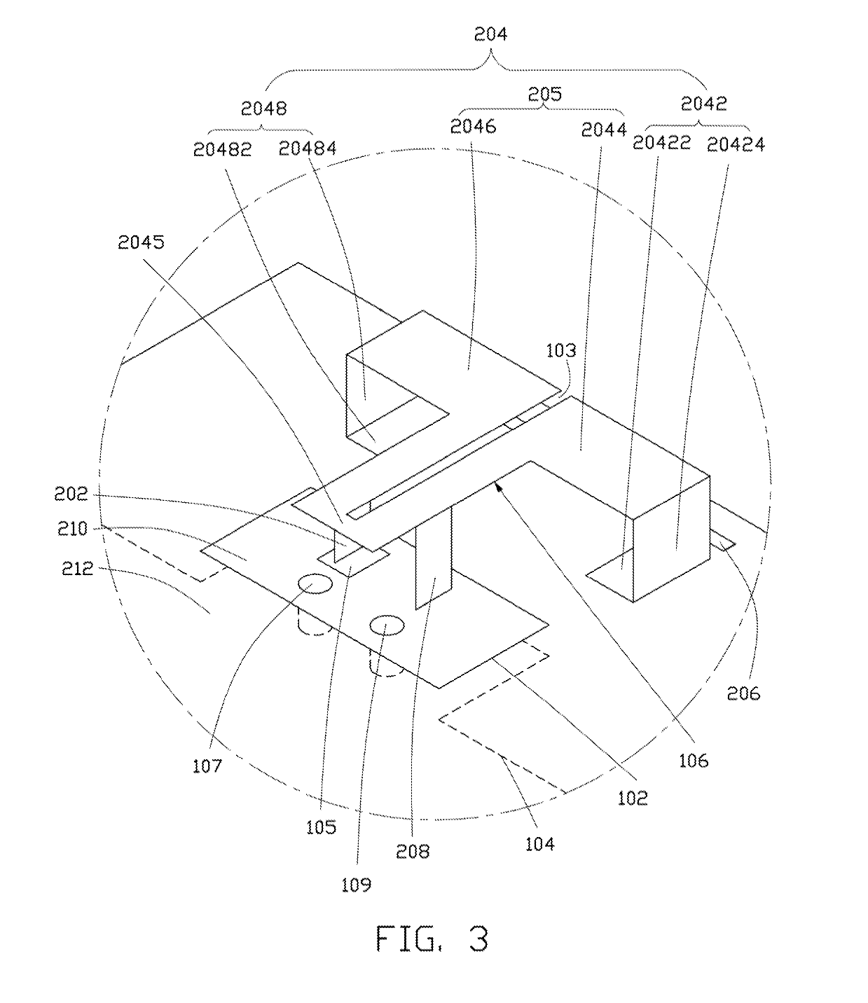

FIG. 3 shows a partial enlargement of the solid antenna 20 shown in FIG. 1 in accordance with the present disclosure.

The first grounding portion 210 including a grounding metal layer is disposed on the first surface 102 of the substrate 10. In the present embodiment, the grounding metal layer of the first grounding portion 210 defines a slot 105. The second grounding portion 212 including a grounding metal layer is disposed on the second surface 104 of the substrate 10. The first grounding portion 210 and the second grounding portion 212 are electrically connected through vias 107 and 109.

The feeding portion 202 is operable to feed electromagnetic wave signals and includes rectangular micro-strips. In the present embodiment, a first end of the feeding portion 202 extends to the substrate 10 through the slot 105 while a second end of the feeding portion 202 is connected to the radiating portion 204.

The radiating portion 204 includes a first radiating part 2042, a second radiating part 2044, a connection part 2045, a third radiating part 2046, and a fourth radiating part 2048 connected in series. In the present embodiment, the feeding portion 202 is perpendicularly connected to the third radiating part 2046.

In the present embodiment, the second radiating part 2044, the connection part 2045, and the third radiating part 2046 are disposed on a plane 106 parallel to the substrate 10. The second radiating part 2044 and the third radiating part 2046 are both in the shape of an “L”. A first end of the second radiating part 2044 and a first end of the third radiating part 2046 are oppositely disposed to form a gap 103 and are connected by the connection part 2045, to improve radiating performance of the solid antenna 20. A second end of the second radiating part 2044 and a second end of the third radiating part 2046 extend in opposite directions and are connected to the first radiating part 2042 and the fourth radiating part 2048 respectively. In the present embodiment, the radiating portion 204 as a whole forms a “T”-shaped structure. The gap 103 is disposed on a center line of the “T”-shaped structure. The first radiating part 2042 and the fourth radiating part 2048 form two ends of the radiating portion 204 and both are in contact with the substrate 10.

The first radiating part 2042 includes a first radiating section 20422 and a second radiating section 20424 perpendicularly connected to the first radiating section 20422. In the present embodiment, the first radiating section 20422 is disposed on the first surface 102 of the substrate 10 while the second radiating section 20424 is perpendicularly connected to the second radiating part 2044. Thus, the first radiating part 2042 extends from the plane 106 to the first surface 102 of the substrate 10 so as to form a solid structure.

The fourth radiating part 2048 includes a third radiating section 20482 and a fourth radiating section 20484 perpendicularly connected to the third radiating section 20482. In the present embodiment, the third radiating section 20482 is disposed on the first surface 102 of the substrate 10 while the fourth radiating section 20484 is perpendicularly connected to the third radiating part 2046. Thus, the fourth radiating part 2048 extends from the plane 106 to the first surface 102 of the substrate 10 so as to form a solid structure.

In the present embodiment, the dimensions of the second radiation section 20424 are substantially identical to those of the fourth radiating section 20484, while the dimensions of the first radiation section 20422 are substantially identical to those of the third radiating section 20482. In the present embodiment, a distance between the plane 106 and the first surface 102 of the substrate 10 is substantially identical to the length of the second radiating section 20424. Thus, the first radiating part 2042, the second radiation part 2044, the connection part 2045, the third radiating part 2046 and the fourth radiating part 2048 collectively form a solid structure standing on the first surface 102 of the substrate 10.

The line of the coupling portion 206 is disposed on the first surface 102 of the substrate 10. In the present embodiment, the coupling portion 206 is disposed away from the feeding portion 202 and is parallel to both of the first radiating section 20422 and the third radiating section 20482 of the radiating portion 204. Accordingly, electromagnetic wave signals can be coupled to improve and further optimize directivity and radiating performance of the solid antenna 20.

The shorting portion 208 is composed of rectangular micro-strips. In the present embodiment, the shorting portion 208 is perpendicular to the substrate 10, where a first end of the shorting portion 208 is connected to the first grounding portion 210 and a second end of the shorting portion 208 is connected to the second radiating part 2044. In the present embodiment, the dimensions of the shorting portion 208 are identical to those of the feeding portion 202. Further, the shorting portion 208 and the feeding portion 202 are on either side of the gap 103 and connected to the radiating portion 204, so that the center portion of the radiating portion 204 is separated from the substrate 10 via the shorting portion 208 and the feeding portion 202. The elevation of the structure hereinbefore mentioned leads to more significant improvements in the radiating performance of the solid antenna 20.

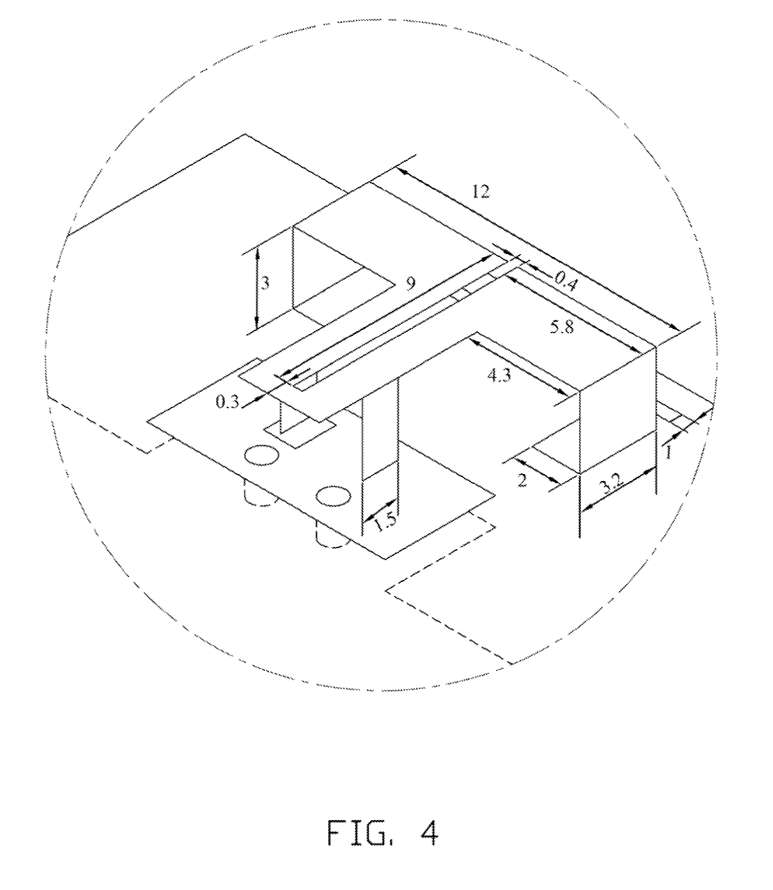

FIG. 4 shows the solid antenna 20 with exemplary designated sizes in millimeters (mm) As shown in the exemplary embodiment of FIG. 4, the length and width of each of the first radiating sections 20422 and the third radiating sections 20482 are 2 mm and 3.2 mm, respectively. The length and width of each of the second radiating section 20424 and the fourth radiating section 20484 are 3 mm and 3.2 mm, respectively. The length and width of each of the feeding portion 202 and the shorting portion 208 are 3 mm and 1.5 mm, respectively. The length and width of the gap 103 is 9 mm and 0.4 mm, respectively. The length and width of the connection part 2045 is 0.3 mm and 0.4 mm, respectively. The length and width of the coupling portion 206 is 12 mm and 1 mm, respectively.

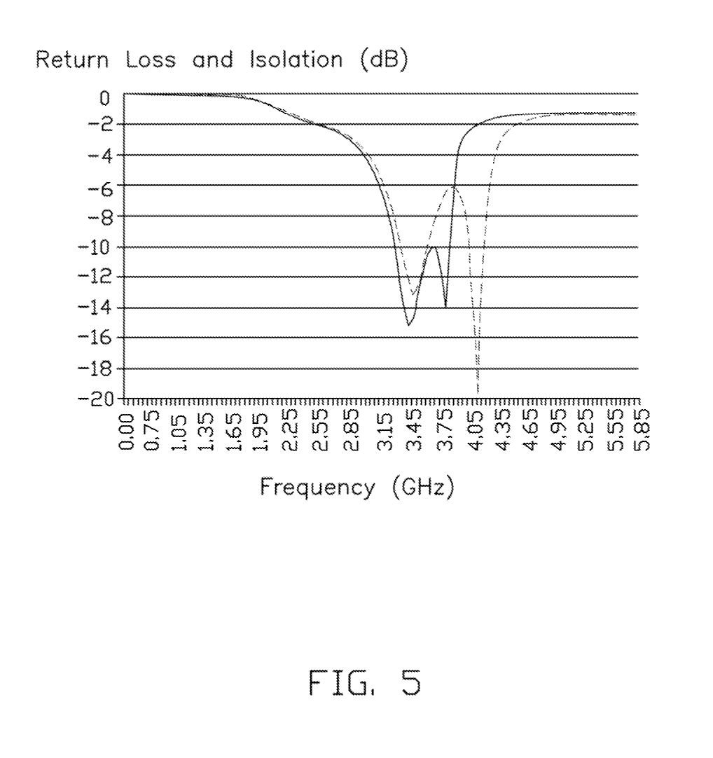

FIG. 5 shows exemplary return loss measurement for the solid antenna 20 shown in FIG. 1. Solid lines represent return loss measurement generated by the solid antenna 20 installed with the coupling portion 206, while dotted lines represent return loss measurement generated by the solid antenna 20 without the coupling portion 206.

The solid antenna 20 installed with the coupling portion 206 broadens bandwidth, allow the solid antenna 20 to work within the 3.4 GHz-3.8 GHz radio frequency bands and enables attenuation range to be less than −10 dB.

The solid antenna 20 of the present disclosure is installed with the coupling portion 206 to achieve greater bandwidth. Further, a solid radiating structure implemented with a radiating portion 204 installed, which reaches two grounding portions in different shapes, brings down the overall size of the solid antenna 20 and furthermore provides better radiating performance

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A solid antenna disposed on a substrate, comprising:
a first grounding portion, disposed on the substrate;
a feeding portion, perpendicular to the substrate and operable to feed electromagnetic wave signals to the solid antenna;
a radiating portion operable to radiate the electromagnetic wave signals, comprising a first radiating part, a second radiating part, a connection part, a third radiating part, and a fourth radiating part connected in series, wherein the third radiating part is perpendicularly connected to the feeding portion while the second radiating part, the connection part, and the third radiating part are disposed on a plane parallel to the substrate, a first end of the second radiating part and a first end of the third radiating part are oppositely disposed and forms a gap between the second radiating part and the third radiating part that are connected via the connection part, a second end of the second radiating part and a second end of the third radiating part extend in opposite direction and respectively connected to the first radiating part and the fourth radiating part, and both the first radiating part and the fourth radiating part extend from the plane to the substrate; and
a coupling portion disposed on the substrate, and separated from the radiating portion.

2. The solid antenna as claimed in claim 1, further comprising a shorting portion formed as a line in perpendicular to the substrate, wherein a first end of the shorting portion is connected to the first grounding portion while a second end of the shorting portion is connected to the second radiating part.

3. The solid antenna as claimed in claim 1, wherein the first radiating part comprises a first radiating section and a second radiating section perpendicularly connected to the first radiating section, wherein the first radiating section is disposed on the substrate and is parallel with the coupling portion while the second radiating section is connected to one of the first and second ends of the second radiating part.

4. The solid antenna as claimed in claim 1, wherein the fourth radiating part comprises a third radiating section and a fourth radiating section perpendicularly connected to the third radiating section, the third radiating section is disposed on the substrate and is parallel to the coupling portion, and the fourth radiating section is connected to one of the first and second ends of the third radiating part.

5. The solid antenna as claimed in claim 1, wherein the first grounding portion defines a slot through which one end of the feeding portion extends to the substrate.

6. The solid antenna as claimed in claim 5, further comprising a second grounding portion which is disposed on a surface of the substrate in opposite to the first grounding portion and is connected to the first grounding portion through a via.

7. A solid antenna disposed on a substrate, comprising a feeding portion, a radiating portion, a shorting portion and a grounding portion disposed on the substrate, wherein both ends of the radiating portion contacts the substrate while a center portion of the radiating portion is separated from the substrate by the feeding portion and the shorting portion, and the shorting portion is connected to a position between the radiating portion and the grounding portion.

8. The solid antenna as claimed in claim 7, wherein the center portion of the radiating portion comprises a T-shaped structure and a center line of the T-shaped structure defines a gap.

9. The solid antenna as claimed in claim 8, wherein the feeding portion and the shorting portion are respectively connected to both sides of the gap of the radiating portion.

10. The solid antenna as claimed in claim 9, further comprising a coupling portion, disposed near both sides of the radiating portion and far away from one side of the feeding portion.
